(19) United States
(12) Patent Application Publication
(10) Pub. No.: US 2005/0189907 A1
(43) Pub. Date: Sep. 1, 2005

(54) Charger of an electric hair cutter having sterilization means

(76) Inventor: Soon-Sik Kim, Seoul (KR)

Correspondence Address: GREENBLUM & BERNSTEIN, P.L.C., 1950 ROLAND CLARKE PLACE, RESTON, VA, 20191, US

(21) Appl. No.: 10/843,368

(22) Filed: May 12, 2004

(30) Foreign Application Priority Data
Feb. 26, 2004 (KR) 2004-0012904

(51) Int. Cl. B26B 19/00

(52) U.S. Cl. 320/107

(57) ABSTRACT

A charger of an electric hair cutter having sterilizing means for charging a battery installed in the hair cutter comprising, a main body having various components therein; a sterilization room formed on an upper surface of the main body to be upwardly inclined and protruded, adapted to be opened and closed by a cover, and provided with a switch at a certain place contacting the cover for turning on/off an ultraviolet lamp; a receiving groove formed in a center part of the sterilization room to be upwardly opened and provided with gripping recesses at both sides thereof and a supporting step at a lower end thereof, the supporting step being provided with a charging terminal connected to a circuit, for mounting a hair cutter having a battery terminal therein; an ultraviolet lamp mounted at an upper part of the sterilization room and emitting ultraviolet having a sterilizing power by a power supply; and a reflecting plate mounted to a rearward region of the ultraviolet lamp and focusing the emitted ultraviolet to the hair cutter.

### RELATED APPLICTION

This is a continuation of Korean application serial number 2004-0012904, filed Feb. 26, 2004, (pending).

### BACKGROUND OF THE INVENTION

1. Field of the Invention

The present invention relates to a charger of an electric hair cutter having sterilization means, and more particularly to a charger of an electric hair cutter having sterilization means wherein the sterilization means consisting of an ultraviolet sterilizing lamp is provided in the charger for charging a battery of the hair cutter, so that sterilization action of sterilizing various disease-causing germs can be achieved with strong ultraviolet light while charging the battery.

2. Background of the Related Art

A hair cutter that is a tool for getting a haircut is widely used in home as well as a beauty shop and a barber shop. Further, the cutter is used for the sake of animal's beauty and for various purposes in a veterinary hospital and a pet shop, etc.

The hair cutter used as above-mentioned has a generally cylindrical body for easy handling and is electrically operated by a motor for automatically getting a haircut.

In a typical hair cutter, a head part is mounted to a front of a main body and provided with a guide plate closely contacting the scalp. A fixed blade having a pectinate shape is mounted to the guide plate and moving blades that are reciprocated right and left by a motor installed in the main body are positioned to closely contact an upper surface of the fixed blade. Also, various components such as a motor and a charging battery, etc are installed in the main body.

Generally, the hair cutter adopts a wireless charging mode for easy use that it is supplied with a power by a charging battery installed in the main body and thus operated.

Therefore, in the above structured electric hair cutter, when a switch is turned on, the eccentrically connected moving blades are reciprocated right and left by a rotary power of the motor while closely contacting the fixed blade, thereby automatically getting a haircut.

However, since the prior hair cutter is primarily used for many people in the barber shop and the beauty shop, an insanitary problem occurs.

In other words, since the hair cutter used in the barber shop and the beauty shop is used for a few to dozens of persons for a day, there are problems that patients' disease-causing germs such as an influenza virus as well as a variety of skin diseases are easily catching.

In particular, since the blade region of the hair cutter is operated while closely contacting the scalp through the guide plate when getting a haircut, various disease-causing germs are easily contagious. In addition, since the blade region by structural nature is properly moist and warm, various bacilli easily live and propagate themselves in the region, thereby getting worse the problems.

Recently, considering the above problems, a waterproof structure capable of water-washing the blades of the head part is suggested. However, it cannot sterilize various bacilli and remove a bad smell even if it clearly washes an appearance of the hair cutter.

### SUMMARY OF THE INVENTION

Accordingly, the present invention has been made to solve the above-mentioned problems occurring in the prior art. The object of the present invention is to provide a charger of an electric hair cutter having sterilization means being capable of sterilizing various bacilli with strong ultraviolet of an ultraviolet lamp while charging the hair cutter by the charger.

In order to accomplish the object, according to one embodiment of the invention, there is provided a charger of an electric hair cutter wherein a receiving groove for mounting the hair cutter so as to charge a battery installed in the hair cutter is opened and closed by a cover, a charging terminal connected to a battery terminal of the hair cutter is provided to one side of the receiving groove, and an ultraviolet lamp for emitting sterilization ultraviolet by a power supply is mounted to the upside of the receiving groove, thereby sterilizing various bacilli with the strong ultraviolet while charging the battery of the hair cutter.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a general configuration of the present invention;

FIG. 2 is a perspective view showing that a cover is opened in FIG. 1;

FIG. 3 is a side cross-section of FIG. 1;

FIG. 4 an enlarged view showing main parts of FIG. 3;

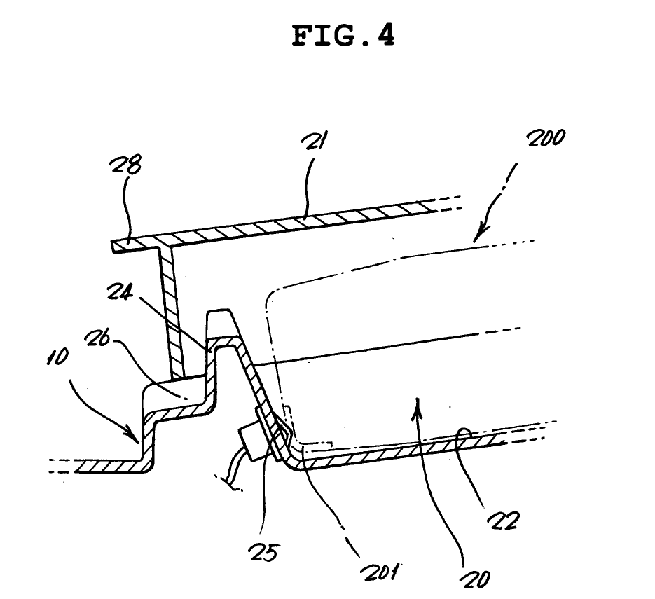

FIG. 5 is a side cross-section showing another embodiment of the invention;

FIG. 6 is an enlarged view showing main parts of FIG. 5; and

FIG. 7 is an illustrative block diagram of the invention.

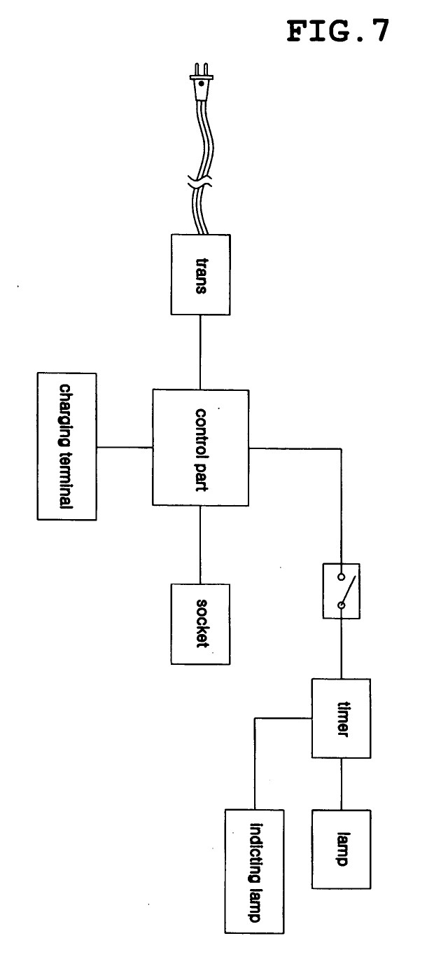

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

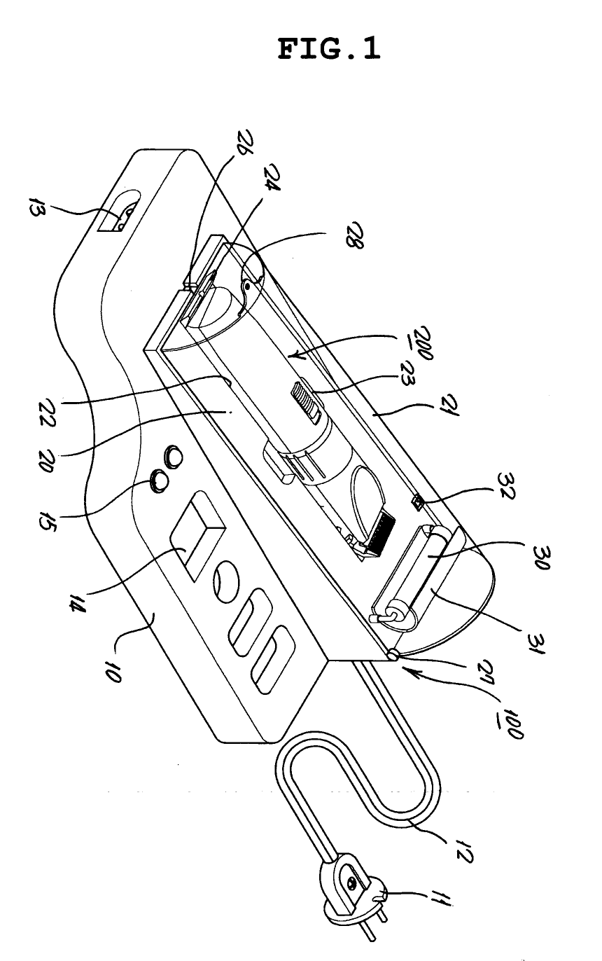

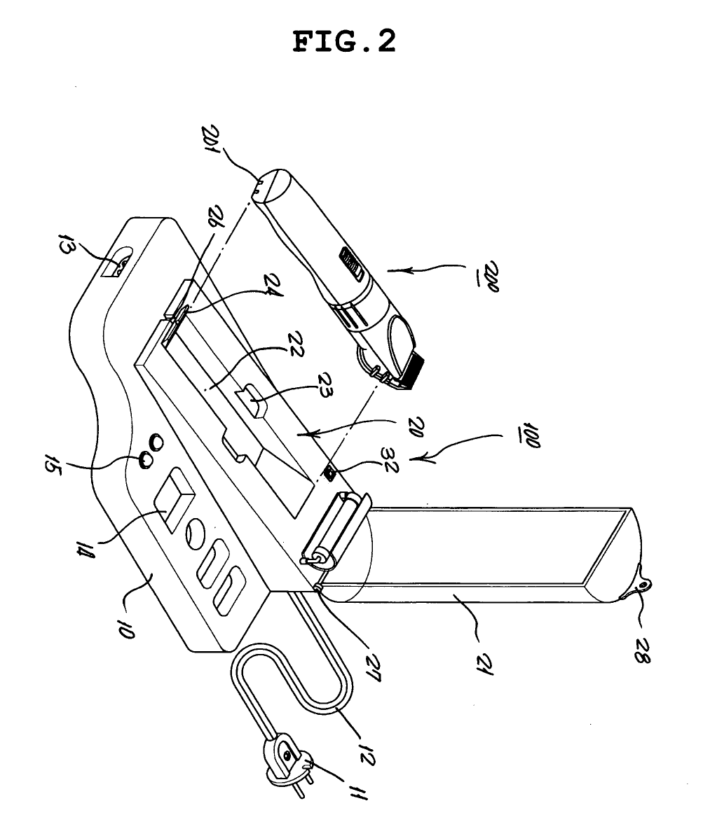

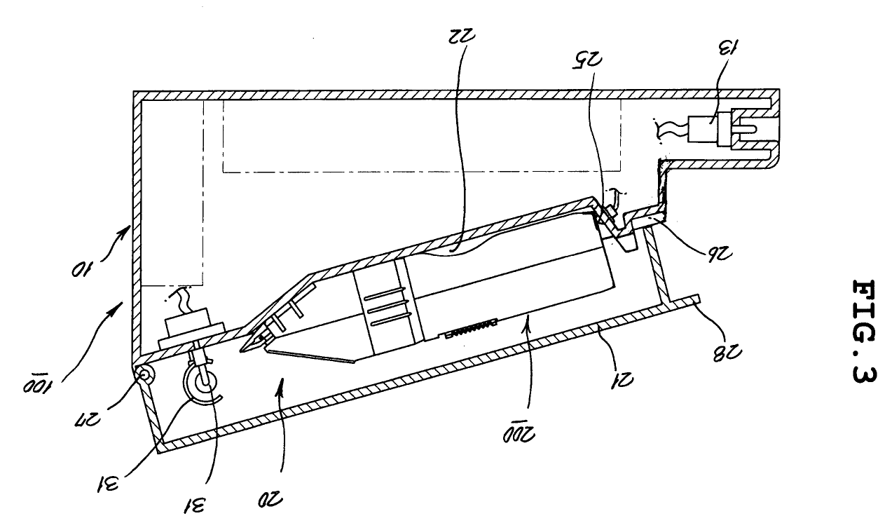

FIGS. 1 and 2 are perspective views illustrating a general structure of the invention. FIG. 3 is a schematic cross-section of the invention. A main body of a charger according to the invention is referred to as a reference numeral 100, and a hair cutter is referred as a reference numeral 200.

The charger 100 comprises a main body 10 for maintaining its overall shape, a sterilization room 20 which is formed on an upper surface of the main body 10, opened and closed by a cover 21 and provided with a hair cutter 200, and an ultraviolet lamp 30 which is installed in an upper side of the sterilization room 20 and emits ultraviolet having strong sterilizing power by a power supply.

The main body 10 is plate-shaped to easily put on the chair or floor, etc. and provided with a variety of electronic, electric and mechanical components necessary for charging a battery of the charger 200 or controlling the ultraviolet lamp 30.

A plug 11 for supplying a power source to the interior components is connected to one side of the main body 10 via an electric cord 12, and a socket 13 for connecting a separate hair cutter 200 is installed in a front side of the main body 10.

A plurality of recesses 14 are formed on a part of the upper surface of the main body 10 for mounting various instruments required in using the hair cutter 200.

The sterilization room 20 formed on the upper surface of the main body 10 is adapted to be opened and closed by the transparent cover 21 and inclined to the main body 10 for easy mounting and removing the hair cutter 200. The interior of the room is provided with a receiving groove 22 for the hair cutter 200.

The receiving groove 22 is longitudinally formed and upwardly opened to stably mount the hair cutter 200. Both sides of the groove are provided with grasping recesses 23 for easy inserting and removing the hair cutter 200.

The receiving groove 22 is formed to provide a room for mounting the hair cutter 200 and preferably has a shape identical to a main body of the hair cutter 200 so as to stably mount the hair cutter. The grasping recesses 23 are provided to easily insert and remove the hair cutter 200.

A supporting step 24 upwardly protruding and inwardly inclined is formed on a lower end of the receiving groove 22 for stably supporting the mounted hair cutter 200. A charging terminal 25 is provided to an inner surface of the supporting step 24 for contacting a battery terminal 201 of the hair cutter 200 mounted in the receiving groove 22.

The charging terminal 25 is connected to a circuit installed in the main body 10, so that it closely contacts the battery terminal 201 provided to a bottom side of the hair cutter 200 when the cutter is mounted, and thus applying an electric current is achieved.

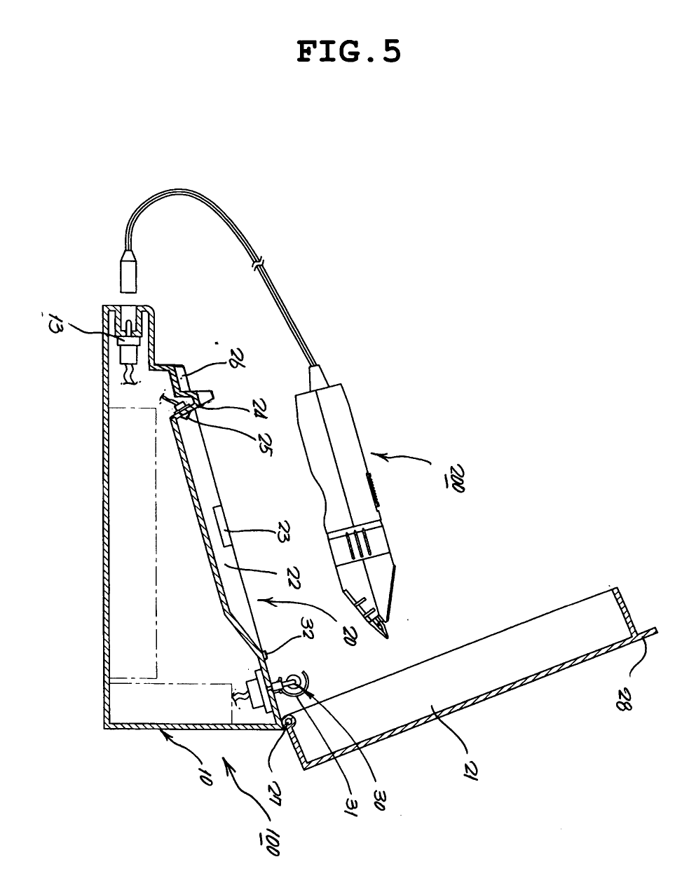

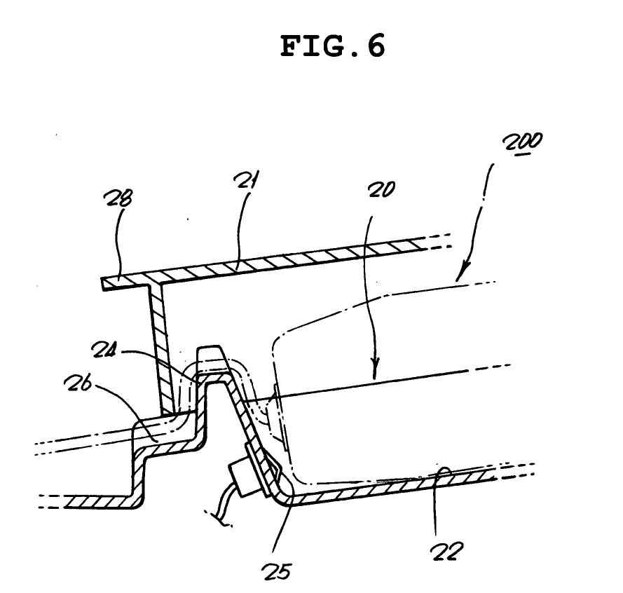

A passage 26 is formed in the supporting step 24, which is provided for a hair cutter 200 having no battery terminal 201 and connected to a wire, as shown in FIGS. 5 and 6.

In other words, the passage 26 provides a room for mounting the wire of the hair cutter 200 to be connected to the socket 13 formed on the front side of the main body 10.

Further, the cover 21 for opening and closing the sterilization room 20 is formed to pivot about a rearward hinge shaft 27. A frond end of the cover is provided with a knob 28 for opening and closing the cover. The cover 21 is preferably transparent to see through the interior thereof.

A reference numeral 15 indicates a charging indicating lamp.

The ultraviolet lamp 30 for emitting ultraviolet is installed in the upper part of the sterilization room 20.

The ultraviolet lamp 30 is mounted to the upside of the receiving groove 22 in the sterilization room 20 and provided to emit ultraviolet. A reflecting pate 41 is provided to a rearward region of the lamp 30 for focusing the emitted ultraviolet on a head part of the hair cutter 200 mounted in the receiving groove 22.

The ultraviolet lamp 30 is preferably located to a certain position deviating from a range of mounting the hair cutter 200 so as to prevent it from being damaged when the hair cutter 200 is mounted. The lamp is turned on and off by an on/off switch 32 that is connected to a control circuit installed in the main body 10 and positioned on a certain place of the main body 10 contacting the cover 21.

That is, the on/off switch 32 is mounted on the main body 10 so as to contact the cover 21 when the cover is closed. Accordingly, the switch is turned on and off when the cover 21 is closed and opened, respectively, thereby turning on and off the ultraviolet lamp 30.

The above structure of the on/off switch 32 is only illustrative. In other words, it is understood that the switch can be positioned on another place of the main body 10 for manually turning on and off.

The ultraviolet lamp 30 is provided for the purpose of effectively sterilizing the hair cutter 200 using ultraviolet. The ultraviolet light emitted from the lamp is a radiation having a wavelength ranging from 100 nm (X-ray) to 400 nm (a visible ray) and classified into a UV-A (long wave) having a wavelength ranging from 320 nm to 400 nm, a UV-B (medium wave) having a wavelength ranging from 280 nm to 320 nm and a UV-C (short wave) having a wavelength ranging from 100 nm to 280 nm.

The ultraviolet light has a strong sterilizing power to sterilize and disinfect various bacteria and bacilli. The sterilizing effect is strongly exhibited in a range of 210˜329 nm, most strongly in a range of 250˜260 nm.

Accordingly, the ultraviolet lamp 30 is one designed to effectively and plentifully emit the ultraviolet of 253.7 nm having a strongest sterilizing effect as already known. Further, since the ultraviolet lamp has an excellent sterilizing effect, an economical efficiency and a convenience, etc., it is variously applied to diverse fields of indoor air sterilization, food rottenness or mold prevention, water sterilization, a package and a receptacle etc. as well as a pharmaceutical company, a research institute and a hospital, etc.

Further, the ultraviolet lamp 30 has functions of emitting ultraviolet, producing ozone and anions and deodorizing, etc.

The hair cutter charger of the invention having the above-mentioned structure is typically used. Specifically, the states of the hair cutter 200 mounted to the charger 100 according the invention and being charged are shown in FIGS. 1 and 3. As shown, when the hair cutter 200 is put into the receiving groove 22 of the sterilization room 20, the battery terminal 201 of the hair cutter 200 is correctly contacted to the charging terminal 25 applying a charging current, so that the battery installed in the hair cutter is charged.

At this time, when the hair cutter 200 is exactly received in the groove 22, the charging indicating lamp 15 is turned on. Accordingly, the correctly received status of the hair cutter can be checked with the naked eye.

At the same time, since the cover 21 of the sterilization room 20 is maintained to be closed, the switch 32 is turned on by the closed cover, thereby causing the ultraviolet lamp 30 in the sterilization room 20 to be operated.

The ultraviolet lamp 30 is turned on by a driving circuit of a control part installed in the main body 10 and thus emits strong ultraviolet. The emitted ultraviolet is intensively focused on the head part of the hair cutter 200 by the reflecting plate 31, thereby effectively sterilizing and disinfecting the hair cutter 200.

On the contrary, when it is desired to use the charged hair cutter 200, a user opens the cover 21 with the knob 28 and takes out the hair cutter 200 from the receiving groove 22.

At this time, when the cover 21 is opened, the on/off switch 32 is turned off and thus the ultraviolet lamp 30 is immediately turned off. Accordingly, the ultraviolet is not directly emitted to a human body and thus safety is assured.

Meanwhile, the above embodiment displays that the hair cutter 200 is wirelessly charged. On the other hand, when the hair cutter 200 is wiredly charged, a jack of the hair cutter 200 is inserted into the socket 13 provided to the front side of the main body 10 and the wire thereof is positioned through the main body 10 and the passage 26 of the supporting step 24. Accordingly, the charging and the ultraviolet sterilization can be simultaneously achieved.

As explained in above, according to the invention, the hair cutter widely used in a barber shop, a beauty shop and a pet shop, etc. is sterilized and disinfected by the ultraviolet lamp while being charged.

Even when the hair cutter is used for a few to dozens of persons, it can be sterilized while being charged, so that infection by various disease-causing germs can be prevented. That is, the present invention provides a very hygienic effect.

Further, according to the invention, a manufacturing capacity is improved because the structure is simplified and a convenience of use is also improved since the sterilizing device is operated only by mounting the hair cutter in the charger.

While the invention has been shown and described with reference to certain preferred embodiments thereof, it will be understood by those skilled in the art that various changes in form and details may be made therein without departing from the spirit and scope of the invention as defined by the appended claims.

1. A charger of an electric hair cutter having sterilizing means for charging a battery installed in the hair cutter comprising,
a main body;
a sterilization room formed on an upper surface of the main body to be upwardly inclined and protruded, adapted to be opened and closed by a cover, and provided with a switch at a certain place contacting the cover that turns on/off an ultraviolet lamp;
a receiving groove formed in a center part of the sterilization room to be upwardly opened and provided with gripping recesses at both sides thereof and a supporting step at a lower end thereof, the supporting step being provided with a charging terminal connected to a circuit, for mounting a hair cutter having a battery terminal therein;
an ultraviolet lamp mounted at an upper part of the sterilization room and emitting ultraviolet having a sterilizing power by a power supply; and
a reflecting plate mounted to a rearward region of the ultraviolet lamp and focusing the emitted ultraviolet to the hair cutter.

2. The charger according to claim 1, further comprising a passage formed in the main body and the supporting step of the sterilization room and leading to the exterior for mounting a wire of the hair cutter, wherein the hair cutter having the wire can be put into the receiving groove and thus charged and sterilized at the same time.

3. The charger according to claim 1, wherein the on/off switch can be separately provided on the main body for manually turning on and off.
